(19) United States
(12) Patent Application Publication
(10) Pub. No.: US 2014/0156404 A1
(43) Pub. Date: Jun. 5, 2014

(54) TARGETED ADVERTISEMENT CALENDAR INCENTIVES AND UPDATES

(71) Applicant: INTERNATIONAL BUSINESS MACHINES CORPORATION, Armonk, NY (US)

(72) Inventors: Alfredo Aldereguia, Cary, NC (US); Jeffrey R. Hamilton, Pittsboro, NC (US); Clifton Kerr, Durham, NC (US); Grace A. Richter, Raleigh, NC (US)

(73) Assignee: International Business Machines Corporation, Armonk, NY (US)

(21) Appl. No.: 13/689,921

(22) Filed: Nov. 30, 2012

(51) Int. Cl. G06Q 30/02

(52) U.S. Cl. CPC G06Q 30/0257
USPC 705/14.55

(57) ABSTRACT

A method and system for generating consumer interest in broadcast advertising that contains encoded advertising incentives. The method includes receiving content from a broadcast stream provider and using a decoder with a processor that executes a software program tool embodied therein. The processor of the decoder executes the steps of the software program tool to detect the presence of advertising incentives in the broadcast stream. The processor of the decoder detects and responds to commands from the control device to display details about the advertising incentive. The processor of the decoder sends notifications to the user, updates the user's calendar, and sends feedback to the advertiser that the advertisement was chosen and accepted by the user.

### FIELD

The present invention relates generally to a method and system of targeted advertising placement using a communications network.

### BACKGROUND

Broadcast communications may carry advertisements, for example, television commercials. Broadcasts of a commercial nature, such as the playoff series for a national sporting event, command a premium for advertising placement because it is likely that the advertisement will be seen by a much larger than normal audience. Further, such highly viewed broadcasts command premiums for advertising because there is a finite supply of advertising time available to satisfy the demand.

However, an advertising campaign that relies on the broad-based technique of placing an advertisement before the widest possible audience is both inefficient and costly. Various television ratings firms may attempt to match viewing habits with other demographic information, resulting in advertising targeted to that audience. Other techniques for capturing broadcast viewing behavior may include using the cable, satellite, and similar delivery devices to track the preferences of their subscribers. These techniques are inefficient because viewers may ignore or avoid the advertisements. Even when the advertisement is viewed, the advertiser is generally unable to quickly determine its effectiveness until after the total sales for the particular good or service are calculated.

It would therefore be desirable to provide an improved method and system of targeted advertising placement in broadcast communications.

### BRIEF SUMMARY

According to an aspect of the invention, a method for a targeted advertisement to a user includes: receiving content from a broadcast data stream using a decoder having a processor for executing a program embodied on a non-transitory computer readable storage medium therein, the content including a plurality of advertisements containing respective advertising incentives encoded therein, the program being encoded to perform the following; polling a control device for input from a user, the control device communicating with the decoder, the decoder being configured for receiving input from the user; displaying on a display device at least one of the plurality of advertisements and a link to at least one of the respective plurality of advertising incentives; decoding and displaying the advertising incentive encoded within the displayed advertisement when the user selects the link to view the advertising incentive being provided by an advertiser; sending a notification which includes the advertising incentive the user selected to a receiving device specified by the user; and generating a feedback notification to the advertiser using the decoder when the user accepts the notification at the receiving device.

In another aspect of the invention, a decoder readable storage medium storing a program of instructions executable by a processor to perform a method of providing a targeted advertisement to a viewer includes: polling a control device for input from the viewer; displaying an advertising incentive on a display device when the viewer selects the advertising incentive and the advertisement being provided by an advertiser; generating feedback to the advertiser when the viewer selects the advertising incentive; and sending a notification to a receiving device for receipt by the viewer.

In another aspect of the invention, A system for providing a targeted advertisement to a user, includes: a decoder having a processor for executing a software program embodied on a non-transitory computer readable storage medium therein and configured to receive content from a broadcast data stream, the content containing a plurality of advertisements containing advertising incentives therein; a control device for polling for input from a user, the control device communicating with the decoder, the decoder being configured for receiving input from the user; a display device for displaying at least one of the plurality of advertisements and a link to at least one of the respective plurality of advertising incentives to the user; a receiving device specified by the user for receiving a notification which includes an advertising incentive selected by the user, wherein the notification includes one or more of: an email, a voicemail, a calendar entry, or an icon; a data record layout for an advertiser feedback notification record generated by the software program from advertising incentive data stored in non-transitory decoder readable storage within the decoder; a module for sending the advertiser feedback notification record to the advertiser for the advertising incentive selected by the user; and a module for sending the notification which includes the advertising incentive the user selected to the receiving device specified by the user.

### BRIEF DESCRIPTION OF THE SEVERAL VIEWS OF THE DRAWING

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic diagram of an exemplary hardware environment used for capturing and processing viewer selection in accordance with the embodiment of the invention depicted in FIG. 2; and

FIG. 2 is a flow diagram illustrating an overview of the methodology of the present disclosure in one embodiment of the present disclosure.

### DETAILED DESCRIPTION

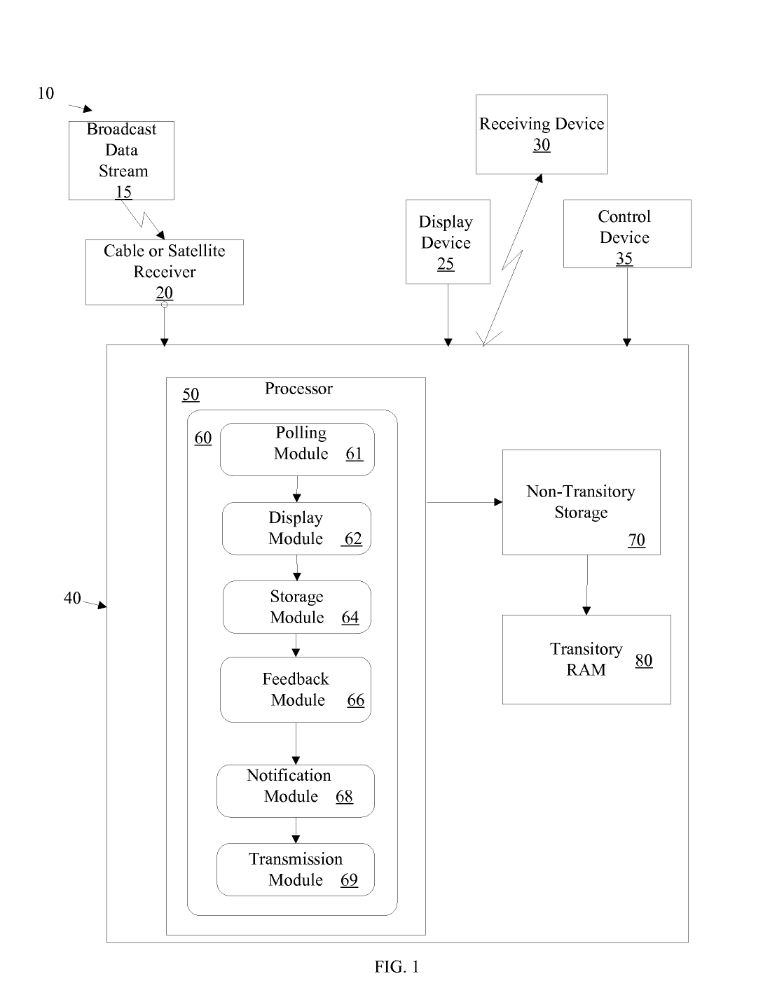

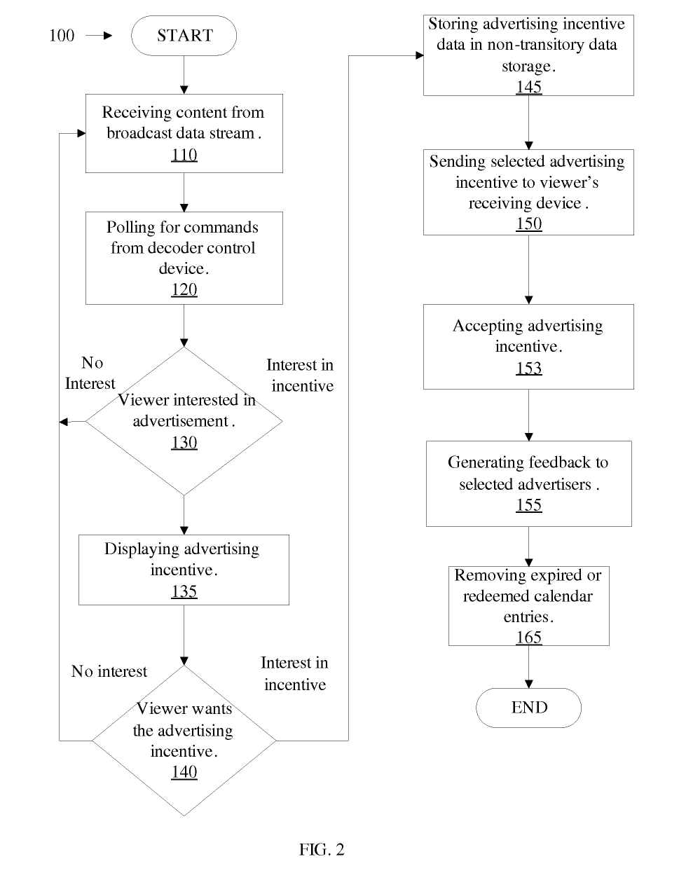

Referring to FIGS. 1 and 2, a system 10 and a method 100 according to an embodiment of the invention, provides targeted advertisements and associated advertising incentives to a user who views the advertisements. Step 110 of method 100 of FIG. 2 includes receiving content from a broadcast data stream 15 through a receiver 20, such as a cable or satellite television set top box. The broadcast data stream 15 is then received by a decoder 40 which may be connected to the receiver using one of many audio/visual signal technologies including, for example, radio frequency (RF) coaxial cable, S-Video composite cable, RCA component cable, High Definition Multimedia Interface (HDMI), Universal Serial Bus (USB), or Firewire. Step 110, at least in part, may be implemented using a processor 50 for executing a software program 60 embodied on a decoder readable medium or a non-transitory data storage device 70. The non-transitory data storage device 70 may include a hard drive, read-only memory, or flash memory.

Step 120 includes polling for commands from a control device, embodied as a control device 35 and a polling module 61 in FIG. 1. The polling module 61 polls for input from a user. The input may be in the form of a selection or a positive indication toward a selected advertisement viewed on the display device 25 and selected using the control device 35. Upon receiving the input, the polling module 61 transfers control to one or more program modules within the program 60, to perform one or more actions, including displaying an advertising incentive, receiving an advertising incentive, or canceling the selection. The control device 35 may include a remote control, or a software application on a mobile personal device, such as a smartphone, laptop, or tablet. The viewer may initiate commands to the decoder 40 using one of many modes. In one embodiment, where the control device 35 is a remote control, the user initiates commands to the decoder 40 by pressing buttons associated with specific tasks, for example, “select” or “cancel.” In this embodiment, the remote control may use infrared (IR) pulses of light or radio-frequency (RF) radio waves that represent specific binary codes that correspond to commands, such as “select” or “cancel.” Similarly, the control device 35 may be a voice activated remote control that may be programmed to learn the viewer's voice command, for example, for “select” or “cancel,” and generate the corresponding IR signal to the decoder 40. In another embodiment, the control device 35 may be a mobile personal device configured with a customized software application. The customized software application may be programmed to emulate the functionality of a remote control. Common programming languages used to build a customized software application on a mobile personal device include OpenGL, Java, or Objective-C. Similar in operation to the remote control, the software application on a mobile personal device generates the binary code corresponding to the IR light pulses that control the decoder 40. A commercially-available IR-emitter is attached to the mobile personal device and completes the communication link between the decoder 40 and the mobile personal device.

Step 130 includes displaying on a display device 25 at least one of the plurality of advertisements and a message indicating that additional information, for example an advertising incentive, encoded within the advertisement may be displayed using the control device 35. In one embodiment, the associated advertising incentive may be displayed, as described in detail below. Alternatively, the viewer may be redirected to a channel that the broadcast provider dedicates to displaying additional advertising content. The display device 25 may be a multi-media terminal configured to display graphics, images, and text data. Other forms of display device include a television, a smartphone, a mobile personal computer, for example, a tablet or laptop, a mobile gaming device, or a media player.

Displaying the advertising incentive in step 135 may include time shifting, a technique that uses redirecting the broadcast data stream from the display device 25 to a temporary storage area within the decoder 40 for the duration of displaying the advertising incentive, giving the viewer the opportunity to decide whether to accept the advertising incentive. The temporary storage area may include a non-transitory data storage device 70 or transitory RAM 80, both managed by a storage module 64. In one embodiment, the advertising incentive data is encoded within the broadcast data stream in a common format, for example, Moving Picture Experts Group (MPEG). The display module 62 extracts and formats the advertising incentive data for display on the viewer's display device 25. The viewer may select not to receive the advertising incentive by inputting a command on the control device 35 to cancel the advertising incentive display, whereupon the broadcast data stream is redirected to the display device 25 and the temporary storage area is purged of the saved broadcast data stream. In another embodiment, the viewer may be redirected to a channel that the broadcast provider dedicates to displaying additional advertising content.

In step 140, the viewer may input the command to select to receive the advertising incentive displayed in step 135. In step 145, advertising incentive data may be stored in non-transitory data storage 70 for later retrieval as input to feedback to the advertisers. The advertising incentive data may be stored using one of many formats, for example, hierarchical database, sequential record of fixed or variable length, or indexed file organization.

Step 150 includes the display module 62 and the storage module 64 executing for decoding and displaying the advertising incentive encoded within the displayed advertisement when the user selects a link to view the advertising incentive being provided by an advertiser. The link may be, for example, a separate element on or attached to the advertisement, the advertisement itself may be the link, or a dialog box may incorporate the link. In one embodiment, the advertising incentive data could be formatted in a language that the receiving device 30 could interpret. The transmission module 69 may send the formatted advertising incentive data to the receiving device 30 using a network protocol, such as Bluetooth or TCP/IP over a wired or wireless LAN. An exemplary advertising incentive coded in Extensible Markup Language (XML) follows:

```
<advertisement>
      <company>IBM</company>
      <title>Smarter Planet, Pure Flex x86 Servers</title>
      <version>1.0</version>
      <incentive type=“coupon” id=“b3f3112ca”
      expiration=“01302013”>
            <voidrule>
                  <uses>1</uses>
            </voidrule>
            <product>
                  <name>IBM Flex System x440 Compute
                  Node</name>
                  <machinetype>7917-AC1</machinetype>
                  <model>AC1</model>
            </product>
            <discount type=“percent”>
                  <range start=“01012013” end=“01082013”>
                        <value>20</value>
                  </range>
                  <range start=“01092013” end=“01302013>
                        <value>10</value>
                  </range>
            </discount>
      </incentive>
</advertisement>
```

In another embodiment, the notification module 68 and the transmission module 69 may transmit a Uniform Resource Locator (URL) reference to a remote server containing the advertising incentive to the receiving device 30. In step 153 in either embodiment, a software application on the receiving device 30 receives the advertising incentive and creates one or more calendar entries in the viewer's calendar, each entry corresponding to a day an event in the advertising incentive is schedule to occur. Simultaneously, the notification module 68 sends an electronic notification to the receiving device 30. The electronic notification may include, for example, an email, a voicemail, or an icon. In step 165, the viewer further may configure the software application on the receiving device 30 to periodically update the calendar to remove expired and/or redeemed advertising incentives. Thereby, expired advertising incentives may be removed after expiration, and additionally or alternatively, the advertising incentives may be removed after they are redeemed, that is, used by the user.

Step 155 includes the storage module 64 extracting the advertising incentive data from the non-transitory data storage 70 to generate feedback notification to advertisers using the decoder when the user selected to receive the advertising incentive. The storage module 64 may create a separate temporary work area for each unique identifier associated with an advertiser. The feedback module 66 formats an advertiser feedback record according to a data record layout that may contain an identification code associated with the advertising incentive, a date and time the viewer selected the advertising incentive, a unique identifier associated with the broadcast provider's cable or satellite receiver, and a unique identifier associated with the advertiser. The feedback module 66 may cooperate with the transmission module 69 to add network-specific header and trailer information to groups of advertiser feedback records in preparation for transmission. In one embodiment, the decoder 40 may be connected to a public network through, for example, broadband or modem. Alternatively, the decoder 40 may be connected to the cable or satellite receiver, using, for example, Internet Protocol Television (IPTV). The transmission module 69 may transmit the groups of advertiser feedback records directly to the individual advertisers, or alternatively, to the broadcast data stream provider. The storage module 64 may purge the temporary work areas and the non-transitory storage 70 following the transmission of the advertiser feedback records.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing a targeted advertisement to a user, comprising:
receiving content from a broadcast data stream using a decoder having a processor for executing a program embodied on a non-transitory computer readable storage medium therein, the content including a plurality of advertisements containing respective advertising incentives encoded therein, the program being encoded to perform the following;
polling a control device for input from a user, the control device communicating with the decoder, the decoder being configured for receiving input from the user;
displaying on a display device at least one of the plurality of advertisements and a link to at least one of the respective plurality of advertising incentives;
decoding and displaying the advertising incentive encoded within the displayed advertisement when the user selects the link to view the advertising incentive being provided by an advertiser;
sending a notification which includes the advertising incentive the user selected to a receiving device specified by the user; and
generating a feedback notification to the advertiser using the decoder when the user accepts the notification at the receiving device.

2. The method of claim 1, wherein the connection between the decoder and the broadcast data stream receiver includes: radio frequency (RF) coaxial cable; S-Video composite cable; RCA component cable; High Definition Multimedia Interface (HDMI); Universal Serial Bus (USB); and Firewire.

3. The method of claim 1, wherein the control device is one or more of: a smartphone; a remote control; a personal data assistant; a mobile personal computer; a mobile gaming device; or a media player.

4. The method of claim 1, wherein the display device is one or more of: a smartphone; a personal data assistant; a television; a mobile personal computer; a mobile gaming device; or a media player.

5. The method of claim 1, wherein the receiving device is one or more of: a smartphone; a personal data assistant; a mobile personal computer; a mobile gaming device; a social network; or a media player.

6. The method of claim 1, wherein the notification is one or more of: an email; an icon; a voicemail; or a calendar entry.

7. The method of claim 1, wherein the user initiates the input to the control device using a voice.

8. The method of claim 1, wherein the user initiates the input to the control device by pressing a button on the control device, the button initiating a software program that sends a signal to the display device.

9. The method of claim 1, wherein the step of displaying the advertising incentive on the display device further comprises:
pausing and redirecting the broadcast data stream from the display device to a temporary storage area in the decoder for the duration of the advertisement;
storing advertising incentive data in non-transitory decoder readable storage within the decoder in response to the user's selection;
displaying the advertising incentive on the display device;
redirecting the broadcast data stream from the temporary storage area in the decoder to the display device in response to user input to resume the broadcast data stream; and
purging the broadcast data stream from the temporary storage area in the decoder.

10. The method of claim 1, further comprising:
generating an advertiser feedback record from the advertising incentive data stored in non-transitory computer readable storage within the decoder, the advertiser feedback record including: date and time a user selected an advertising incentive; a unique identifier associated with an advertising incentive; a unique identifier associated with a user; and a unique identifier associated with a target device; and
purging the advertising incentive data from the non-transitory decoder readable storage within the decoder after transmitting the advertiser feedback record.

11. The method of claim 1, further comprising:
creating one or more calendar entries on the user's receiving device, each entry corresponding to a day an event in the advertising incentive is scheduled to occur, and simultaneously sending an electronic notification to the receiving device, wherein the electronic notification includes one or more of: an email; a voicemail; or an icon; and
removing an expired and/or a redeemed advertising event entry from the calendar on the receiving device.

12. A computer readable storage medium storing a program of instructions executable by a processor to perform a method for providing a targeted advertisement to a user, the program being encoded to perform the following:
receiving content from a broadcast data stream using a decoder having a processor for executing a program embodied on a non-transitory computer readable storage medium therein, the content including a plurality of advertisements containing respective advertising incentives encoded therein, the program being encoded to perform the following:
polling a control device for input from a user, the control device communicating with the decoder, the decoder being configured for receiving input from the user;
displaying on a display device at least one of the plurality of advertisements and a link to at least one of the respective plurality of advertising incentives to the user;
decoding and displaying the advertising incentive encoded within the displayed advertisement when the user selects the link to view the advertising incentive being provided by an advertiser;
sending a notification which includes the advertising incentive the user selected to a receiving device specified by the user;
generating a feedback notification to the advertiser using the decoder when the user accepts the notification at the receiving device.

13. The computer readable storage medium of claim 12, wherein an advertising feedback record includes: date and time a user selected the advertising incentive; a unique identifier associated with the advertising incentive; a unique identifier associated with the user; and a unique identifier associated with the receiving device.

14. The computer readable storage medium of claim 12, wherein the step of displaying the advertising incentive on the display device further comprises:
pausing and redirecting the broadcast data stream from the display device to a temporary storage area in the decoder for the duration of the advertisement;
storing advertising incentive data in non-transitory decoder readable storage within the decoder in response to user selection;
displaying the advertising incentive on the display device;
redirecting the broadcast data stream from the temporary storage area in the decoder to the display device in response to user input to resume the broadcast data stream; and
purging the broadcast data stream from the temporary storage area in the decoder.

15. The computer readable storage medium of claim 12, further comprising:
creating one or more calendar entries on the receiving device, each entry corresponding to a day an event in the advertising incentive is scheduled to occur, and simultaneously sending an electronic notification to the receiving device, wherein the electronic notification includes one or more of: an email; a voicemail; or an icon; and
removing an expired and/or a redeemed advertising event entry from the calendar on the receiving device.

16. The computer readable storage medium of claim 12, further comprising:
removing an expired and/or a redeemed advertising event entry from the calendar on the receiving device.

17. A system for providing a targeted advertisement to a user, comprising:
a decoder having a processor for executing a software program embodied on a non-transitory computer readable storage medium therein and configured to receive content from a broadcast data stream, the content containing a plurality of advertisements containing advertising incentives therein;
a control device for polling for input from a user, the control device communicating with the decoder, the decoder being configured for receiving input from the user;
a display device for displaying at least one of the plurality of advertisements and a link to at least one of the respective plurality of advertising incentives to the user;
a receiving device specified by the user for receiving a notification which includes an advertising incentive selected by the user, wherein the notification includes one or more of: an email; a voicemail; a calendar entry; or an icon;
a data record layout for an advertiser feedback notification record generated by the software program from advertising incentive data stored in non-transitory decoder readable storage within the decoder;
a module for sending the advertiser feedback notification record to the advertiser for the advertising incentive selected by the user; and
a module for sending the notification which includes the advertising incentive the user selected to the receiving device specified by the user.

18. The system of claim 17 wherein the control device is one or more of: a smartphone; a remote control; a personal data assistant; a mobile personal computer; a mobile gaming device; or a media player.

19. The system of claim 17, wherein the display device is one or more of: a smartphone; a personal data assistant; a television; a mobile personal computer; a mobile gaming device; or a media player.

20. The system of claim 17, wherein the receiving device is one or more of: a smartphone; a personal data assistant; a mobile personal computer; a mobile gaming device; a social network; or a media player.
